(19) United States
(12) Patent Application Publication
(10) Pub. No.: US 2008/0209238 A1
(43) Pub. Date: Aug. 28, 2008

(54) CONTROLLER FOR PROCESSING APPARATUS

(75) Inventor: Anthony Craig DOLWIN, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/955,846

(22) Filed: Dec. 13, 2007

(30) Foreign Application Priority Data
Feb. 22, 2007 (GB) 0703484.6

(51) Int. Cl. G06F 1/00

(52) U.S. Cl. 713/300

(57) ABSTRACT

DVS control is established by determining a voltage frequency profile for a processing resource completing a task within a timing deadline. The voltage frequency profile is determined by way of constraining the available operating frequency to a number of discrete permitted operating frequencies. In one embodiment, acceptance of the voltage frequency profile is carried out by determining if the processing resource will carry out a task within an acceptable time period. In one embodiment, this is assessed by reference to a worst case cycle count for the task concerned.

The present invention is concerned with control of processing apparatus, and is particularly, but not exclusively, concerned with control of a CMOS based integrated circuit.

It is well known that the maximum operating frequency of CMOS technology increases generally with supply voltage. Using this, power consumption of a CMOS device can be controlled by operating the device at the lowest clock frequency permitted for a particular operating requirement and taking the opportunity arising from this to limit supply voltage. This has been achieved in the prior art by fixing the supply voltage and clock frequency at the time of designing a circuit incorporating a CMOS device.

More recently, the concept of dynamically adjusting the voltage and frequency has been introduced, for instance in “Hard Real-Time Scheduling for Low-Energy Using Stochastic Data and DVS Processors” (Elavius Gruian, International Symposium on Low Power Electronics and Design, Huntington Beach (Calif.), US, Aug. 6-7, 2001 (revised September 2001)) and “PACE: A new approach to dynamic voltage scaling” (Jacob R. Lorch, Alan Jay Smith, IEEE Transactions on Computers, Vol. 53, No. 7, July 2004).

This is known as Dynamic Voltage Scaling (DVS). DVS has been used in applications such as a PC where real-time deadlines are not required, for instance in “System level adaptive framework for power and performance scaling on Intel/spl reg/PXA27x processor” (Vaidya, P. N.; Khan, M. H.; Morgan, B.; Sakarda, P., Proceedings of IEEE International Conference on Acoustics, Speech, and Signal Processing, 18-23 Mar. 2005, Vol. 5, Page(s):v/657-v/660).

A particular area of interest is the implementation of DVS techniques in real-time applications. An example application would be a handheld telecommunication device such as a 3G mobile phone.

The signal processing required by telecommunication equipment can often be defined as a sequence of operations on one or more blocks of data. In the past, these operations were relatively simple but more recently the algorithms associated with these operations have become more complicated and tend to have variable complexity. In addition, with the introduction of software defined radio and cognitive radio into such equipment, operations can also change dynamically to match prevailing conditions.

This level of variability introduces a number of difficulties when designing such a system especially when hard real time deadlines must be met while still achieving low power consumption. Traditionally, the designer of a CMOS ASIC would specify the components to implement the maximum complexity envisaged. To do this, the worst case complexity would be estimated and then clock frequencies and supply voltages would be specified to match. This approach can be more power hungry than the ideal, because average complexities in use of the device over time may be significantly lower than the worst case.

Adaptive Dynamic Voltage Scaling addresses this problem by monitoring the complexity of an operation and then altering the supply voltage and frequency during future executions of the operation to ensure power consumption is kept under control while still achieving the required timing deadlines.

The concept of adjusting the operating frequency and voltage has been outlined by Lorch and Smith (see above). In that paper, the technique used to do this is known as the PACE (Processor Acceleration to Conserve Energy) algorithm. Gruian (see above) also describes a similar idea.

UK Patent Application GB2410344A describes a specific method for calculating the voltage profile where a discrete number of frequency steps (or phases) are supported but with no constraint on the granularity of the frequency value.

In patent US20050132238A1 a range of metrics (including cycle count) is described. These metrics are used to determine the future setting of the clock frequency. The calculation of the clock frequency is achieved using a look up table. However, this method does not describe how, in a real-time system, hard deadlines can be met; further, it does not discuss altering the clock frequency during execution of a task to ensure that deadlines are met.

U.S. Pat. No. 7,131,015 is a high level description of technology termed “Intelligent Energy Manager” by the applicant thereof. That document describes how an operating system can be used to determine performance requirements in a system where asynchronous processing requests occur, for instance the depression of a mouse button to initiate a function in a program. It then describes how, in general, these performance requirements can be interpreted into a generic performance request on the processor. A more detailed implementation description is given in “Automatic Performance-setting for Dynamic Voltage Scaling” (Flautner et al., Proceedings of the International Conference on Mobile Computing and Networking, July 2001).

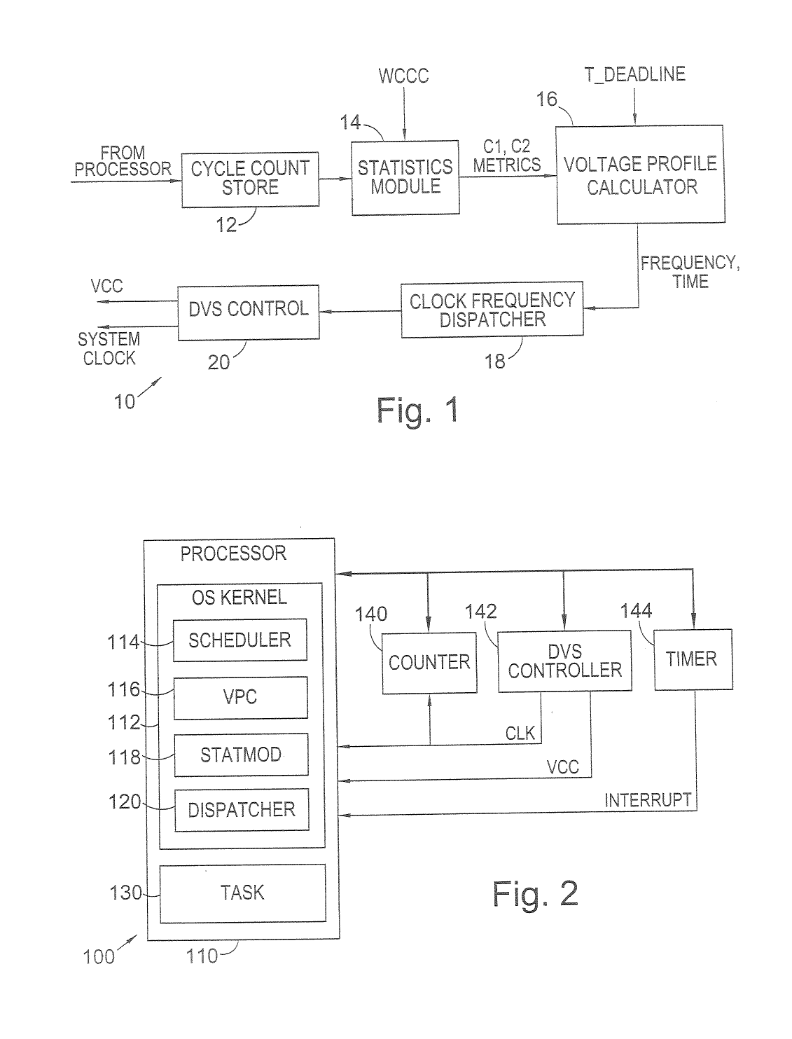

As an example of the type of arrangement known from the prior art, FIG. 1 illustrates schematically a controller 10 for a processor (not shown). The controller comprises a cycle count store 12, which monitors processor activity in connection with tasks assigned to the processor, in accordance with voltage frequency profiles established by the controller 10. A statistics module 14 records this activity. The statistics module also receives as an input the worst case cycle count (wccc), which is provided for the task in question by the computer programmer. Statistics (C1, C2) are passed to a voltage profile calculator 16, which calculates an appropriate voltage frequency profile with respect to a timing deadline T_{d} also supplied by the computer program, and the input statistics (C1,C2).

The voltage profile calculator 16 outputs frequency and time profile criteria which are passed to a clock frequency dispatcher 18. The clock frequency dispatcher converts the frequency and time profile information into clock frequency information to configure a DVS control unit 20. The DVS control unit 20 finally converts the clock frequency information into a supply voltage VCC and a system clock signal. These are then used to drive the processor.

Earlier work assumed the clock frequency could be controlled accurately while in practise some platforms may only offer as little as 4 clock frequencies. If the methods described in the prior art are used in a system using quantised VE values the calculated VF would have to be directly quantised and this would result in an inefficient profile.

An aspect of the present invention provides a method of controlling a processing resource, said processing resource being controllable by way of supply voltage and clock frequency, the method comprising defining an operating profile comprising one or more operating phases, each phase being defined by way of operation of said processing resource for a selected period at an operating frequency being a member of a set of permitted operating frequencies and setting operating voltage during each phase corresponding to said selected operating frequency.

In general terms, an aspect of the invention concerns controlling a processing resource such that said processing resource is operated at an operating frequency selected from a constrained set of pre-determined values.

Another aspect of the invention provides a method of determining an operation profile for a processing resource, comprising recording history of operational complexity and, on the basis of said history, calculating said operation profile, said profile being determined from a finite set of available clock frequencies. Preferably, said operation profile defines maximum durations allowed at each frequency.

Another aspect of the invention provides a method of determining a voltage frequency profile for performance of a function at a processing resource in accordance with dynamic voltage scaling, the profile comprising a plurality of phases, wherein in each phase the profile defines a frequency value, selected from a set of pre-determined frequency values, at which said processing resource is to operate for that phase.

In one embodiment of this aspect of the invention, the length in time of each phase is determined by way of a cycle count vector representing the probability distribution function (PDF) for the number of cycles required for the function to complete. The PDF may be calculated from monitoring the number of cycles required to complete the function in the past and incrementing a counter associated with a range of values. The counters may be scaled according to the number of times the function has executed to get a probability density value for each range.

In one embodiment of this aspect of the invention, in each phase the profile defines an operation voltage at which the processing resource is to be driven. The voltage may be a supply voltage and/or a bias voltage.

In another embodiment of this aspect of the invention, the cycle count is transformed into a duration by multiplying the length of each phase in cycle counts by the clock period associated with that phase.

Another aspect of the invention provides DVS control by determining a voltage frequency profile for a processing resource completing a task within a timing deadline. In this aspect of the invention, the voltage frequency profile is determined by way of constraining the available operating frequency to a number of discrete permitted operating frequencies. In one embodiment, acceptance of the voltage frequency profile is carried out by determining if the processing resource will carry out a task within an acceptable time period. In one embodiment, this is assessed by reference to a worst case cycle count for the task concerned.

Aspects of the present invention can be incorporated into any low power equipment supporting reconfigurable functionality or functions with variable complexity and hard timing constraints. These can include embedded processors, system-on-a-chip (SoC), laptop computers, and communication equipment. Further, the invention can be implemented by way of software, for instance as a reconfiguration of an existing DVS hardware based controller. This can be provided as a download such as on a signal, or as a product introduced on a storage medium.

A specific embodiment of the invention will now be described, with reference to the accompanying drawings, in which:

FIG. 1 is a schematic diagram of a DVS controller in accordance with a prior art example,

FIG. 2 is a schematic diagram of a processing apparatus in accordance with a specific embodiment of the invention, including a DVS controller;

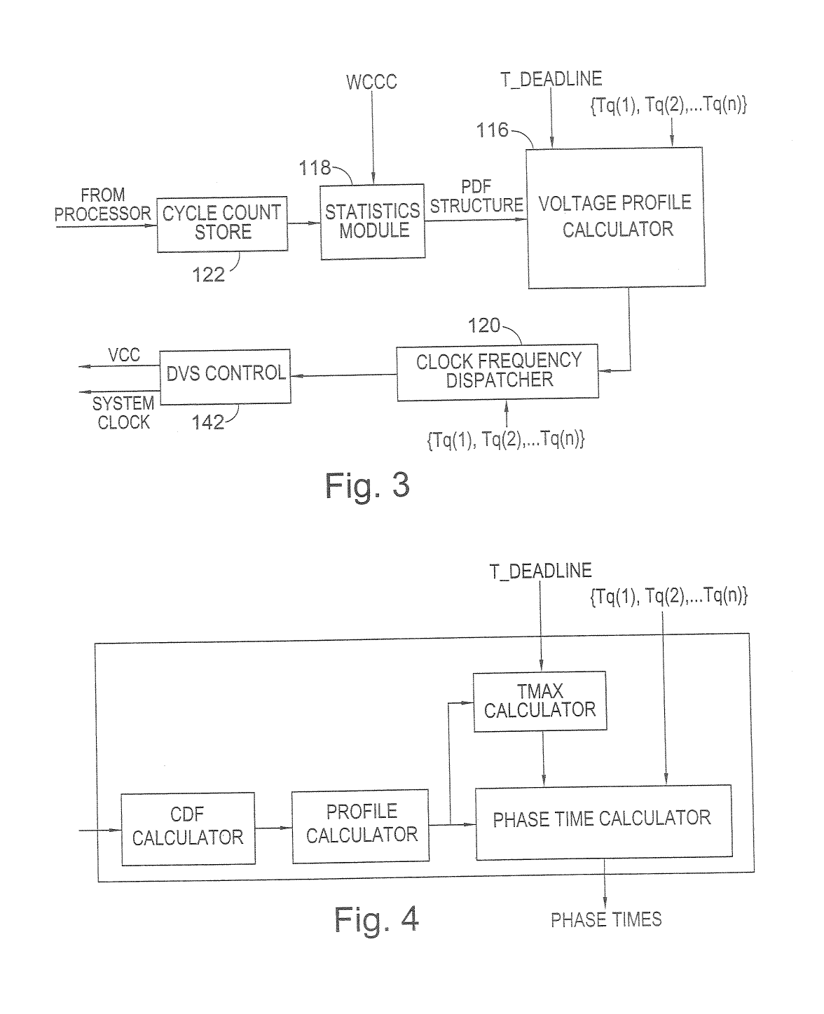

FIG. 3 is a schematic diagram of a DVS controller in accordance with a specific embodiment of the invention;

FIG. 4 is a schematic diagram of a voltage profile calculator of the DVS controller illustrated in FIG. 3;

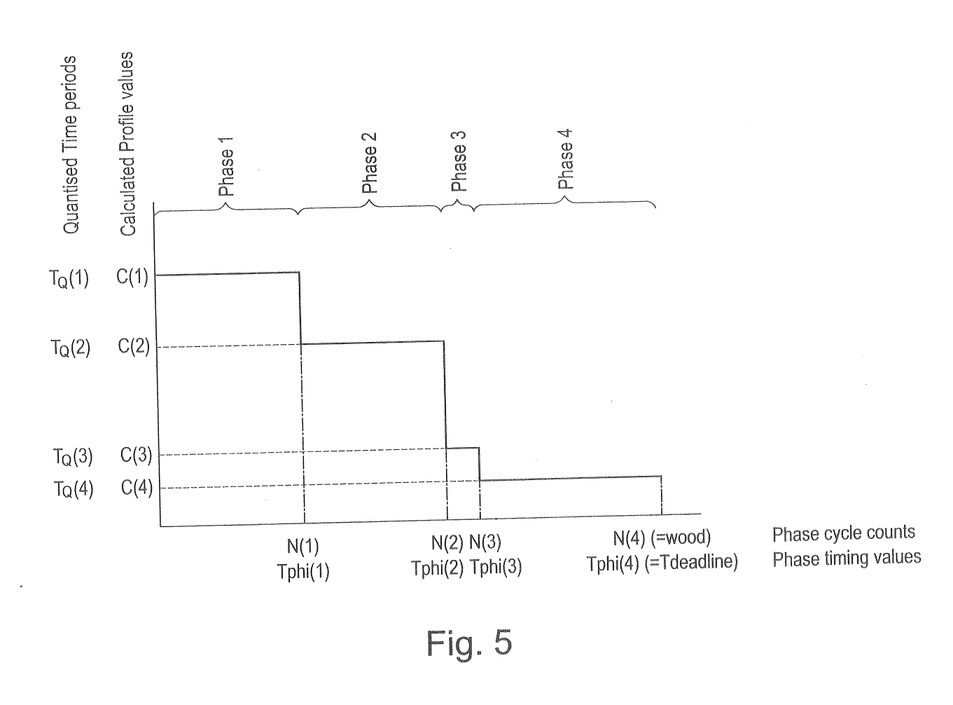

FIG. 5 is a phase diagram illustrating a voltage frequency profile for the specific embodiment of the invention;

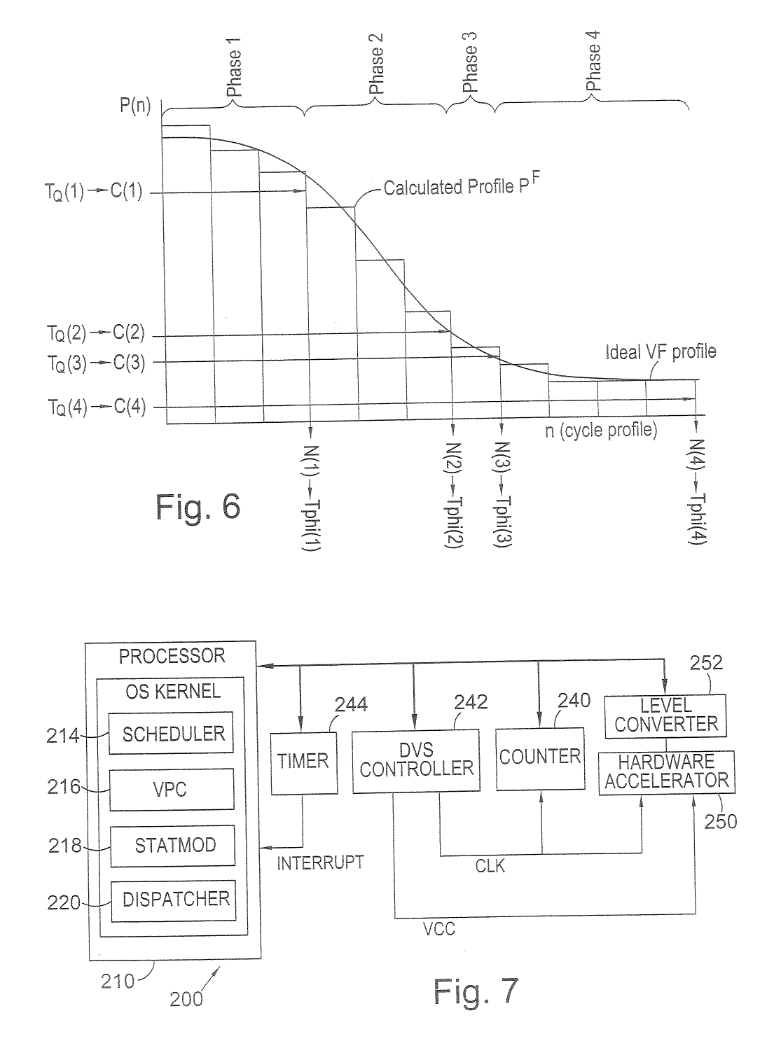

FIG. 6 is a graph illustrating calculation of the voltage frequency profile in comparison with an ideal voltage frequency profile for a given exemplary task; and

FIG. 7 is a schematic diagram of a processing apparatus in accordance with a further specific embodiment of the invention.

The specific embodiment of the invention now described illustrates how the voltage-frequency (VF) profile for a task or function executing on platform supporting DVS can be calculated for quantised voltage-frequencies. This approach assumes only a limited number of operating frequencies can be used and then the algorithm described below calculates the duration for which the circuit stays in each frequency phase.

In this disclosure, “VF profile” refers to the manner in which the frequency of the clock supplied to a processing module, and therefore the associated supply voltage, is altered during the execution of a function. In practical implementations, the profile always starts at a low frequency (and low voltage) and increases with time. “Frequency Phase” refers to a period in time during which the circuit is operating at a fixed clock frequency and an associated supply voltage. Phase 1 uses T_{Q}(1), phase 2 uses T_{Q}(2) and phase N uses T_{Q}(N), where there are N phases and T_{Q}(x)>T_{Q}(x+1), and where T_{Q}( ) refers to the clock period of the clock of the processing module.

A typical computer hardware apparatus 100 is illustrated in FIG. 2. This apparatus could be provided on a mobile telephone handset, or any other hardware device in which in which power consumption is an important issue for user acceptability and operability. The hardware apparatus 100 comprises a processor 110, which is illustrated in the present example as being configured by the number of software components. It would be appreciated by the reader that this is for illustrative purposes, and that memory means of various types will inevitably be provided in order to allow this to happen. The processor is configured by an operating system kernel 112, which supports a scheduler 114, a voltage profile calculator 116, a statistics module 118 and a dispatcher 120. A task 130 is also to be executed by the processor 110. Use of the scheduler 114, the voltage profile calculator 116, the statistics module 118 and the dispatcher 120 will be further described in due course with reference to the DVS controller to be described.

The hardware apparatus further comprises a counter 140, configurable by a clock signal generated by DVS controller 142, and further a timer 144. The timer 144 is operable to generate an interrupt to the processor 110 as required.

FIG. 3 illustrates implementation of the DVS controller 142, in conjunction with various of the software modules indicated in FIG. 2. As appropriate, these are given the same reference numerals to aid correspondence between the two figures. These are given the corresponding reference numerals in FIG. 3.

The example in FIG. 2 is merely one example of use of a DVS in accordance with the specific embodiment of the invention as described above. In the arrangement illustrated in FIG. 2, a suitable processor is the ARM1176 processor, developed by ARM Ltd. of Cambridge, U.K. This is an example of a processor which supports a real-time multitasking operating system. The product is suitable for incorporation into a mobile telephone handset and so, one of the tasks it would support would be a voice codec (namely a vocoder).

A vocoder is normally implemented by way of a software module, and in this example is downloaded as required by the service supplier, and so vocoders of varying complexity can be available. The OS platform would supply a cycle counter which could be read at the start and end of execution of a task so that the number of cycles required to complete a given task can be calculated. Using this information as well as the following data embedded into the software module by the programmer:
The worst case cycle count (wccc), and
The timing deadline (T_{d}),

the Operating System would calculate, after the vocoder is executed, the voltage-frequency (VF) profile for the next time the task is executed. When the OS next schedules the vocoder task it would first read the VF profile and configure a low level interrupt routine to interrupt at the appropriate intervals corresponding to each phase and modify the operating frequency (and hence the supply voltage). The vocoder would then be loaded onto the processor and executed (FIG. 2).

It will be appreciated that the wccc measure is a characteristic of the specific vocoder being implemented, and different vocoders can have different wccc values.

The VPC 116 calculates when to switch from one phase to the next, where each phase corresponds to a fixed clock period (frequency). Each phase operates at a smaller clock period (i.e. higher frequency) than the previous phase. The VPC takes a probability distribution function, H^{F}(pdf) as its input. The pdf can be calculated dynamically based on past cycle counts or can be derived from the known characteristics of the function. The H^{F} is a vector where each element corresponds to the probability that the cycle count will be in the range of the associated bin. From this pdf, the cumulative distribution function (cdf) is calculated, and then a Normalized Profile (P^{F}):

$$\begin{matrix}{cdf}^{F} ( j ) = {\sum }_{i = 1}^{i = j} {H}^{F} ( i ) & ( 1 ) \\ {P}^{F} = \sqrt[3]{1 - {cdf}^{F}} & ( 2 )\end{matrix}$$

A scaling factor, T^{F}ₘₐₓ, is then calculated based on the profile (P^{F}), the bin sizes (b) and the timing deadline T_{deadline}:

$${T}_{max}^{F} = \frac{{T}_{deadline}}{{\sum }_{j = 2}^{j = {N}_{bin}} {P}^{F} ( j ) \times ( b ( j ) - b ( j - 1 ) )} \qquad ( 3 )$$

T^{F}ₘₐₓ is the ideal maximum cycle period for this profile. The actual clock period that will be used is then calculated, based on the quantised values in T_{Q}. The index into T_{Q} which identifies the 1^{st} cycle period, I^{F}_{max,} is found by testing each value in T_{Q}, starting at the largest value, to find a cycle period that is equal to or less than T^{F}ₘₐₓ:

iₘₐₓ^{F}=findIndex(T_{Q}<Tₘₐₓ^{F}) (4)

k=iₘₐₓ^{F} (5)

The remainder of the actual clock cycle values (T_{Q}) are then transformed into a Normalized Profile Value by the following algorithm:

repeat:

$$\begin{matrix}C = 0 \\ N = 0 \\ {T}_{Φ} = 0 & ( 6 ) \\ C ( k ) = \frac{{T}_{Q} ( k )}{{T}_{max}^{F}} & ( 7 ) \\ N ( k ) = cinverse ( C ( k ) , {P}^{F} ) & ( 8 ) \\ {T}_{Φ} = {T}_{Q} ( k ) \times N ( k ) & ( 9 ) \\ for \text{:} s = k + 1 \text{:} 1 \text{:} steps & ( 10 ) \\ C ( s ) = \frac{C ( s - 1 ) \times {T}_{Q} ( s )}{{T}_{Q} ( s - 1 )} & ( 11 ) \\ N ( s ) = cinverse ( C ( s ) , {P}^{F} ) & ( 12 ) \\ {T}_{Φ} ( s ) = {T}_{Q} ( s - 1 ) + {T}_{Q} ( s ) \times ( N ( s ) - N ( s - 1 ) ) & ( 13 ) \\ end & \\ k = k + 1 & ( 14 ) \\ until \text{:} worstCycle ( {T}_{Φ} , {T}_{Q} ) \geq wccc & \end{matrix}$$

In the above algorithm:

N_{T} is the number of cycle count values per frame

b(j) is the upper limit of bin range j

steps is the number of discrete operating frequencies (cycle periods) supported by the silicon device concerned;

T_{Q}(1)..(steps) is a vector of all possible cycle period values supported by the silicon device concerned;

T_{deadline} is a scalar value representing a timing deadline for a task to be completed by the silicon device;

H^{F}(1)..(nbin-1) is a pdf vector of cycle counts for frame F;

cdf^{F}(1)..(nbin-1) is the cumulative distribution function (cdf) vector for cycle counts for frame F;

PF(1)..(nbin-1) is the calculated normalized cycle period profile vector following frame F;

Tₘₐₓ^{F} is the ideal maximum cycle period value calculated after frame F;

findindex(T_{Q}≦Tₘₐₓ^{F}) returns an index for a value in the T_{Q} vector which is closest to

T^{F}ₘₐₓ but which is smaller than or equal in value.

iₘₐₓ^{F} is the index into the T_{Q} vector to the cycle period closest to the calculated maximum value;

C(1)..(steps) is a vector of profile values calculated from T_{Q} (see FIG. 5);

N(1)..(steps) is a vector of cycle counts corresponding to the maximum cycle count (from the start) for each phase, where each phase corresponds to a cycle period in T_{Q} (see FIG. 5);

T_{Φ}(1)..(steps) is a vector of completion times for each phase, where each phase corresponds to a cycle period in T_{Q} (see FIG. 5);

nbin is the number of bins;

cinverse(C(s), P^{F}) returns cycle count associated with bin in P that has a value that is closest to C(s). When C(s) is between two bins, the one with the lowest cycle count is returned.

worstCycle(T_{Φ}, T_{Q}) calculates the maximum number of cycles that will be executed in the time deadline, (T_{deadline})

By this algorithm, the cycle count vector H^{F}(df) is transformed into a Normalized Profile (P^{F}) vector. The Normalized Profile defines the clock period relative to the maximum value used at the start of the execution. A normalized clock profile value is derived from a list of quantised clock frequencies, T_{Q} and the timing deadline T_{deadline} (equations 3 and 7). This value is then used with the Normalized Profile vector P^{F} to calculate the number of cycles (N) from the start when the circuit must switch from this clock period to the next smaller clock period (equations 8 & 12). This is in essence calculating the inverse, that is the maximum number of cycles for which the circuit can operate at this clock frequency. The quantised clock periods are ordered, so they start at the longest and progressively get smaller.

The algorithm is used to search through the profile data structure (P^{F}) to ascertain the maximum number of cycles for which the system clock can stay in the present clock period (which is the inverse of clock frequency). This is depicted in FIG. 5 and is represented mathematically in equations 6 to 14 above. The calculated cycle count is the latest count, following the start, at which the circuit must switch to the next shortest clock period. Using the cycle counts for previous clock periods as well as the cycle period itself, the transition time between successive quantised clock periods can be calculated, as in equation 13.

After the profile has been calculated, it is tested to determine if sufficient cycles will be executed (i.e. wccc) in the time deadline specified (T_{deadline}). It is possible in some implementations this will not happen. If this is the case, the calculation is repeated, but starting with the next lowest quantised clock period in T_{Q} as the value for the first phase.

FIG. 7 illustrates a further example of use of this specific embodiment of dynamic voltage scaling. This approach, similar to that used in FIG. 2, can be used where the task in question is implemented by a hardware accelerator. For example, a DSP can be used to implement a vocoder, to use the same example. The control processor illustrated then monitors the cycles used by the accelerator to complete the task and then subsequently modifies the operating frequency and voltage of the hardware accelerator only.

The illustrated hardware apparatus 200, as for the apparatus 100 in FIG. 2, comprises a processor 210 executing an operating system kernel 220 on which are supported scheduler 214, voltage profile calculator 216 and statistical module 218 software modules, cooperating with a DVS controller 242. The DVS controller 242 operates in conjunction with a counter 240 and a timer 244 as previously, with the timer 244 sending interrupts to the processor 210 as required in order to cause execution of the various aforementioned software modules.

The vocoder, in accordance with the previous example, is in this embodiment implemented in hardware, specifically a hardware accelerator 250, in conjunction with a level converter 252, to ensure interoperability between the hardware accelerator 250 (which may be a digital signal processor) and the aforementioned processor 210.

In this embodiment, the DVS controller 242 sends CLK and VCC signals to the hardware accelerator 250, on the basis of monitoring, by the control processor 210 of the operation of the hardware accelerator 250. The monitoring is carried out by the processor 210 on the basis of the ‘STATMOD’ or statistical module 218 executed thereby.

The invention has been illustrated by means of two examples of implementation of a vocoder, one by means of an application specific hardware arrangement (FIG. 7) and the other by way of a software enabled configuration of a more general purpose hardware apparatus (FIG. 2). However, it will be appreciated that the invention is not constrained or limited to specific features of the described embodiments and that other implementations, in hardware, software or a mixture of both, could also be provided. Moreover, the invention should not be considered as limited to apparatus, or a method for performance on such apparatus, and can be considered as relating to a method in general terms, for performance on any suitable apparatus. It can also be considered to relate to software products, such as would be implemented on a storage medium or a signal, for reception by and execution on suitable processing apparatus.

The scope of protection should, in the first instance, be considered as defined in the appended claims which are to be read in conjunction with, but not limited by, the above description and accompanying drawings.

1. A method of controlling a processing resource, said processing resource being controllable by way of supply voltage and clock frequency, the method comprising defining an operating profile comprising one or more operating phases, each phase being defined by way of operation of said processing resource for a selected period of time at an operating frequency being a member of a set of permitted operating frequencies and setting operating voltage during each phase corresponding to said selected operating frequency.

2. A method of controlling in accordance with claim 1, wherein said method comprises operating said processing resource an operating frequency selected from a constrained set of pre-determined values.

3. A method of determining an operation profile for a processing resource, comprising recording history of operational complexity and, on the basis of said history, calculating said operation profile, said profile being determined from a finite set of available clock frequencies.

4. A method in accordance with claim 3 wherein said operation profile defines maximum durations allowed at each frequency.

5. A method of determining a voltage frequency profile for performance of a function at a processing resource in accordance with dynamic voltage scaling, the profile comprising a plurality of phases, wherein in each phase the profile defines a frequency value, selected from a set of pre-determined frequency values, at which said processing resource is to operate for that phase.

6. A method in accordance with claim 5, wherein the length in time of each phase is determined by way of a cycle count vector representing the probability distribution function (PDF) for the number of cycles required for the function to complete.

7. A method in accordance with claim 6 wherein the PDF is calculated from monitoring the number of cycles required to complete the function in the past and incrementing a counter associated with a range of values.

8. A method in accordance with claim 6 wherein the step of determining the length of time in each phase comprises a profile calculation step in which it is determined whether execution of a worst case cycle count can be completed within a specified timing deadline and, if it is determined that said execution cannot be completed, repeating said calculation step over a reduced subset of permitted operating frequencies.

9. A method in accordance with claim 8 wherein said reduced subset includes all permitted operating frequencies considered in the preceding performance of the calculation step except for the lowest frequency considered in the preceding performance of the calculation step.

10. A method in accordance with claim 8 wherein said calculation step is repeated until said worst case cycle count is capable of being performed in accordance with the calculated voltage frequency profile within the specified timing deadline.

11. A method in accordance with claim 6 including transforming the cycle count vector into a duration by multiplying the length of each phase in cycle counts by the clock period.

12. A method in accordance with claim 1 wherein, in each phase, the profile defines an operation voltage at which the processing resource is to be driven.

13. A method in accordance with claim 12 wherein the voltage is a supply voltage and/or a bias voltage.

14. A DVS controller for controlling a processing resource, said processing resource being controllable by way of supply voltage and clock frequency, the controller comprising profile definition means operable to define an operating profile comprising one or more operating phases, each phase being defined by way of operation of said processing resource for a selected period of time at an operating frequency being a member of a set of permitted operating frequencies and voltage setting means operable to set operating voltage of a processing resource during each phase corresponding to said selected operating frequency.

15. A computer comprising a processor means and a DVS controller, the DVS controller being operable to control the processor means by way of operating frequency and/or supply voltage, the controller being operable in accordance with any one of claims 1 to 13.

16. A computer program product for configuring a general purpose computer with a DVS facility, to configure said DVS facility to operate in accordance with any one of claims 1 to 13.
